(19) United States
(12) Patent Application Publication
(10) Pub. No.: US 2025/0243368 A1
(43) Pub. Date: Jul. 31, 2025

(54) CARBON BLACK AND MANUFACTURING METHOD AND APPLICATION THEREOF

(71) Applicant: Linyuan Advanced Materials Technology Co., Ltd., Kaohsiung City (TW)

(72) Inventors: JHENG-GUANG LI, Kaohsiung City (TW); YU-HSUAN CHEN, Kaohsiung City (TW); KUNG-CHENG LIU, Kaohsiung City (TW); YA-SYUAN LIN, Kaohsiung City (TW)

(21) Appl. No.: 19/038,113

(22) Filed: Jan. 27, 2025

(30) Foreign Application Priority Data
Jan. 30, 2024 (TW) 113103570
Jan. 8, 2025 (CN) 202510027545.X

(51) Int. Cl. C09C 1/56; C09C 1/48; C09D 7/61

(52) U.S. Cl. CPC C09C 1/565; C09C 1/482; C09D 7/61; C01P 2002/72; C01P 2006/12; C01P 2006/19; C01P 2006/80

(57) ABSTRACT

A carbon black is provided. The carbon black is produced through heat treatment of recycled carbon black. Since the carbon black is made from recycled carbon black, it is a kind of environmentally friendly carbon black.

### BACKGROUND OF THE INVENTION

### Field of the Invention

This application claims priority under 35 U.S.C. § 119 to Taiwanese Patent Application No. 113103570, filed Jan. 30, 2024. Further, this application claims priority to CN202510027545.X, filed on Jan. 8, 2025. Each of these applications are incorporated by reference herein in their entireties.

The present disclosure relates to a carbon black and application thereof and, in particular, to a low-volatile carbon black obtained from recycled carbon black and application thereof.

### Description of the Prior Art

According to statistics, about 120,000 tons of waste tires are produced in Taiwan every year, and an average of about 10,000 tons of waste tires need to be processed every month. The processed waste tires are mainly used as auxiliary fuel and renewable raw materials, and can be thermally cracked into oil and carbon black for reuse.

However, currently, the carbon black obtained by pyrolysis (recycled carbon black) contains a large amount of impurities, such as zinc oxide, silica, etc., so that the recycled carbon black can only be used as a low-order filler with low economic value, thereby affecting the recycling rate of waste tires.

### SUMMARY OF THE INVENTION

In view of the above, an object of the present disclosure is to provide a carbon black with low impurity content produced from recycled carbon black.

Based on the above object, the present disclosure provides the following carbon black, preparation method of carbon black, use of carbon black, and coating or ink.

Item 1. A carbon black produced by recycling carbon black and meeting the following conditions: less than 3.4% by weight of volatile content.

Item 2. The carbon black of item 1, wherein the volatile content is equal to or less than 3.2% by weight.

Item 3. The carbon black of item 1 or 2, wherein the volatile content is greater than about 0% by weight and less than or equal to about 2.9% by weight.

Item 4. The carbon black of item 1, further meeting the following conditions: an oil absorption number of about 150 mL/100 g or less.

Item 5. The carbon black of item 4, wherein the oil absorption number is about 140 mL/100 g or less.

Item 6. The carbon black of item 4 or 5, wherein the oil absorption number is between about 100 mL/100 g and about 135 mL/100 g.

Item 7. The carbon black of item 1, further meeting the following conditions: a nitrogen adsorption specific surface area of about 40 m²/g or more.

Item 8. The carbon black of item 7, wherein the nitrogen adsorption specific surface area is about 60 m²/g or more.

Item 9. The carbon black of item 7 or 8, wherein the nitrogen adsorption specific surface area is between about 65 m²/g and about 150 m²/g.

Item 10. The carbon black of any one of items 1, 2, 4, 5, 7 and 8, further meeting the following conditions: about 2 ppm or less of polycyclic aromatic hydrocarbons.

Item 11. A carbon black produced by recycling carbon black and meeting the following conditions: a volatile content of greater than about 0% by weight and less than or equal to about 2.9% by weight; and at least one selected from the group consisting of: (1) an oil absorption number between about 100 mL/100 g and about 135 mL/100 g; (2) a nitrogen adsorption specific surface area between about 65 m²/g and about 150 m²/g; and (3) about 2 ppm or less of polycyclic aromatic hydrocarbons.

Item 12. A method for preparing carbon black of any one of items 1 to 11, comprising: (1) providing a recycled carbon black; and (2) performing a heat treatment on the recycled carbon black.

Item 13. The method of item 12, wherein the recycled carbon black is obtained by performing pyrolysis on tires.

Item 14. The method of item 12 or 13, wherein the heat treatment is performed at a temperature equal to or greater than about 800° C.

Item 15. The method of item 14, wherein the heat treatment lasts for about 10 minutes or more.

Item 16. The method of item 12, further comprising: (3) modifying the recycled carbon black after the heat treatment.

Item 17. The method of item 16, wherein the modification is performed with an oxidizing agent.

Item 18. The method of item 16 or 17, wherein the modification is performed with ozone.

Item 19. A use of carbon black of any one of items 1 to 11 in coatings or inks.

Item 20. A coating or ink containing the carbon black of any one of items 1 to 11.

The present disclosure can effectively reduce impurities in recycled carbon black through a simple process, thereby improving the applicability and economic value of recycled carbon black.

### BRIEF DESCRIPTION OF THE DRAWINGS

FIG. 1(a) shows X-ray diffraction analysis pattern of the recovered carbon black after heat treatment; and FIG. 1(b) shows X-ray diffraction analysis pattern of the recovered carbon black before heat treatment.

### DETAILED DESCRIPTION OF THE EMBODIMENTS

In the present disclosure, “between X and Y” is equivalent to “X˜Y”, and the end values X and Y are included.

In the present disclosure, the term “about” can be regarded as modifying the term or numerical value so that the term or numerical value is not an absolute value and cannot be found in the prior art. In some embodiments, the term “about” encompasses the numerical value within 1%, 2%, 3%, 4%, 5%, 6%, 7%, 8%, 9%, or 10% of the measured value (including such value) or the numerical value within any intermediate range (such as ±2%˜6%), which includes at least the degree of expected experimental error, technical error and instrument error of the method, analysis or measurement value.

The carbon black provided by the present disclosure is obtained by recycling carbon black, and meets the following conditions: less than 3.4% by weight of volatile content. In some embodiments, the volatile content of the carbon black is 3.2% by weight or less. In some embodiments, the volatile content of the carbon black is greater than about 0% by weight and less than or equal to about 2.9% by weight. The volatile content (weight %) of carbon black can also be equal to or less than any of the following values, or between the range of any two of the following values: about 2.9, about 2.6, about 2.3, about 2.0, about 1.7, about 1.4, about 1.1, about 0.8, about 0.5, about 0.1, and about 0.01. For example: in some embodiments, the volatile content is between about 0.01 by weight and about 0.8% by weight; and in other embodiments, the volatile content is between about 1.4% by weight and about 2.9% by weight.

The carbon black provided by the present disclosure can further meet the following conditions: an oil absorption number of about 150 mL/100 g or less. In some embodiments, the oil absorption number is about 140 mL/100 g or less. In some embodiments, the oil absorption number is between about 100 mL/100 g and about 135 mL/100 g. In some embodiments, the oil absorption number can be equal to or less than any of the following values, or can be between the range of any two of the following values: about 102 mL/100 g, about 105 mL/100 g, about 108 mL/100 g, about 110 mL/100 g, about 113 mL/100 g, about 115 mL/100 g, about 118 mL/100 g, about 120 mL/100 g, about 123 mL/100 g, about 125 mL/100 g, about 128 mL/100 g, about 130 mL/100 g, about 132 mL/100 g and about 134 mL/100 g.

The carbon black provided by the present disclosure can further meet the following conditions: a nitrogen adsorption specific surface area of about 40 m²/g or more. In some implementations, the nitrogen adsorption specific surface area is about 60 m²/g or more. In some embodiments, the nitrogen adsorption specific surface area is between about 65 m²/g and about 150 m²/g. In some embodiments, the nitrogen adsorption specific surface area can be equal to or greater than any of the following values, or can be between the range of any two of the following values: about 67 m²/g, about 69 m²/g, about 70 m²/g, about 75 m²/g, about 80 m²/g, about 85 m²/g, about 90 m²/g, about 95 m²/g, about 100 m²/g, about 105 m²/g, about 110 m²/g, about 115 m²/g, about 120 m²/g, about 125 m²/g, about 130 m²/g, about 135 m²/g, about 140 m²/g, about 145 m²/g and about 150 m²/g.

The carbon black provided by the present disclosure can further meet the following conditions: about 2 ppm or less of polycyclic aromatic hydrocarbons (PAH). In some embodiments, the content of polycyclic aromatic hydrocarbons can be equal to or lea than any of the following values, or can be between the ranges of any two of the following values: about 2 ppm, about 1.5 ppm, about 1.0 ppm, about 0.5 ppm and about 0 ppm. In another embodiment, the content of 15 PAHs in the carbon black provided by the present disclosure is between about 0 and about 2 ppm, for example: between about 0 and about 1.5; wherein, 15 PAHs refers to the following 15 types of polycyclic aromatic hydrocarbons: Benzo[a]pyrene, Benzo[e]pyrene, Benzo[a]anthracene, Benzo[b]fluoranthene, Benzo[j]fluoranthene, Benzo[k]fluoranthene, Chrysene, Dibenzo[a,h]anthracene, Benzo[g,h,i]perylene, Indeno[1,2,3-cd]pyrene, Anthracene, fluoranthene, phenanthrene, pyrene and Naphthalene.

In some embodiments, the carbon black provided by the present disclosure meets the following conditions: greater than about 0% by weight and less than or equal to about 2.9% by weight of volatile content; and an oil absorption number between about 100 mL/100 g and about 135 mL/100 g. In other embodiments, the carbon black meets the following conditions: a volatile content of greater than about 0% by weight and less than or equal to about 2.9% by weight; an oil absorption number between about 100 mL/100 g and about 135 mL/100 g; and a nitrogen adsorption specific surface area between about 65 m²/g and about 150 m²/g.

In some embodiments, the carbon black provided by the present disclosure meets the following conditions: a volatile content of greater than about 0% by weight and less than or equal to about 2.9% by weight; and a nitrogen adsorption specific surface area between about 65 m²/g and about 150 m²/g. In other embodiments, the carbon black meets the following conditions: a volatile content of greater than about 0% by weight and less than or equal to about 2.9% by weight; a nitrogen adsorption specific surface area between about 65 m²/g and about 150 m²/g; and about 2 ppm or less of polycyclic aromatic hydrocarbons.

In some embodiments, the carbon black provided by the present disclosure meets the following conditions: a volatile content of greater than about 0% by weight and less than or equal to about 2.9% by weight; and about 2 ppm or less of polycyclic aromatic hydrocarbons. In other embodiments, the carbon black meets the following conditions: a volatile content of greater than about 0% by weight and less than or equal to about 2.9% by weight; an oil absorption number between about 100 mL/100 g and about 135 mL/100 g; and about 2 ppm or less of polycyclic aromatic hydrocarbons.

In some embodiments, the carbon black provided by the present disclosure meets the following conditions: a volatile content of greater than about 0% by weight and less than or equal to about 2.9% by weight; an oil absorption number between about 100 mL/100 g and about 135 mL/100 g; a nitrogen adsorption specific surface area between about 65 m²/g and about 150 m²/g; and about 2 ppm or less of polycyclic aromatic hydrocarbons.

In some embodiments, the carbon black provided by the present disclosure meets the following conditions: X-ray diffraction analysis (XRD) pattern comprising three characteristics peaks in 2θ positions at about 28° (e.g. 28.38°±0.2), about 47° (e.g. 47.26°±0.2), and about 56° (e.g. 56.08°±0.2). In some embodiments, the carbon black provided by the present disclosure meets the following conditions: XRD pattern comprising four characteristics peaks in 2θ positions at about 28° (e.g. 28.38°±0.2), about 47° (e.g. 47.26°±0.2), about 56° (e.g. 56.08°±0.2), and about 69° (e.g. 69.08°±0.2). In some embodiments, the carbon black provided by the present disclosure meets the following conditions: XRD pattern comprising five characteristics peaks in 2θ positions at about 28° (e.g. 28.38°±0.2), about 47° (e.g. 47.26°±0.2), about 56° (e.g. 56.08°±0.2), about 69° (e.g. 69.08°±0.2), and about 76° (e.g. 76.37°±0.2).

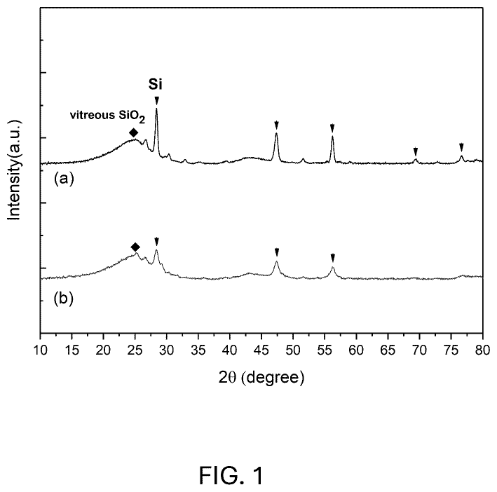

In some embodiments, the carbon black provided by the present disclosure has an X-ray diffraction pattern substantially as shown in FIG. 1(a).

In some embodiments, the carbon black provided by the present disclosure meets the following conditions: an oxygen-containing functional group content of about 70% or less, as measured by X-ray photoelectron spectroscopy (XPS). In some embodiments, the oxygen-containing functional group content can be equal to or less than any of the following values, or between the range of any two of the following values: 68, 64, 59, 54, 49, 44, 39, 35, 30, 25, 20, 15, 10, 5, and 0.

In some embodiments, the carbon black provided by the present disclosure meets the following conditions: a carbon-carbon bond (C—C) content of about 30% or more, as measured by XPS. In some embodiments, the carbon-carbon bond content can be equal to or greater than any of the following values, or can be between the range of any two of the following values: 32, 34, 36, 38, 40, 42, 44, 46, 48, 50, 55, 60, 65, 70, 75, 80, 85, 90, 95, and 100.

In some embodiments, the carbon black provided by the present disclosure meets the following conditions: a carbon-oxygen single bond (C—O) content of about 40% or less, as measured by XPS. In some embodiments, the carbon-oxygen single bond content can be equal to or less than any of the following values, or between the range of any two of the following values: 38, 36, 34, 32, 30, 28, 26, 24, 22, 20, 15, 10, 5, and 0.

In some embodiments, the carbon black provided by the present disclosure meets the following conditions: a carbon-oxygen double bond (C═O) content of about 20% or less, as measured by XPS. In some embodiments, the carbon-oxygen double bond content can be equal to or less than any of the following values, or between the range of any two of the following values: 19, 18, 17, 16, 15, 14, 13, 12, 11, 10, 5, and 0.

In some embodiments, the carbon black provided by the present disclosure meets the following conditions: a carboxyl group (COOH) content of about 1% or more, as measured by XPS. In some embodiments, the carboxyl group content can be equal to or greater than any of the following values, or can be between the range of any two of the following values: 1, 2, 3, 4, 5, 6, 7, 8, 9, 10, 12, 14, 16, 18, and 20.

The present disclosure also provides a method for manufacturing the aforementioned carbon black, which includes: providing a recycled carbon black and performing a heat treatment on the recycled carbon black. The obtained carbon black can satisfy at least one of the aforementioned properties including the oil absorption number, the nitrogen adsorption specific surface area and the polycyclic aromatic hydrocarbons or any combination thereof in addition to satisfying the aforementioned volatile content property.

In the present disclosure, recycled carbon black includes but is not limited to: recycled carbon black purchased from the market, and recycled carbon black obtained from tires using conventional processes. For example, recycled carbon black can be produced by the following method: crushing waste tires; and thermally cracking the crushed waste tires to obtain recycled carbon black. In some embodiments, a catalyst can be added to the crushed waste tires before pyrolysis. The pyrolysis can be carried out at a temperature equal to or less than about 500° C., or between the range of any two of the following values: about 350° C., about 375° C., about 400° C., about 425° C., about 450° C., and about 475° C.

In the present disclosure, the heat treatment for recycled carbon black can be carried out at a temperature equal to or greater than about 800° C., or between the range of any two of the following: about 825° C., about 850° C., about 875° C., about 900° C., about 925° C., about 950° C., about 975° C., about 1000° C. and about 1025° C. The time of heat treatment depends on the temperature of heat treatment. Generally speaking, it can last for equal to or more than about 10 minutes, and can also be between a range of any two of the following values: about 20 minutes, about 30 minutes, about 40 minutes and about 50 minutes. The heat treatment can be carried out under air, and can also be carried out under inert gas (such as nitrogen). The heat treatment can be carried out in a high-temperature furnace, microwave equipment or other devices capable of high-temperature heat treatment.

The method for manufacturing carbon black provided by the present disclosure may further include: modifying the heat-treated recycled carbon black to further obtain modified recycled carbon black. In some embodiments, the modification is an oxidation reaction. For example, in some embodiments, the modification is performed with an oxidizing agent; and in other embodiments, the modification is performed with ozone. The modification time depends on the user's needs. Generally speaking, it can last for equal to or more than 20 minutes, and can also last for any time period between a range of any two of the following values: about 40 minutes, about 60 minutes, about 80 minutes, about 100 minutes and about 120 minutes. For example: in some embodiments, the modification time is between about 40 minutes and about 60 minutes; and in other embodiments, the modification time is between about 80 minutes and about 120 minutes.

The carbon black provided by the present disclosure can be used in coatings, inks or other coating applications (for example, thin films). Carbon black can form a coating on the substrate through conventional coating methods. In some embodiments, carbon black is incorporated into ink for electrostatic printing or inkjet printing. In other embodiments, carbon black is incorporated into the paint for coating.

### [Heat Treated Recycled Carbon Black]

### Production Example 1: Production of Carbon Black 1

The quartz crucible was placed in a high-temperature furnace and baked at 950° C. for 10 minutes to remove impurities in the crucible. Next, 20.0 g of recycled carbon black PB-365 (Enretec Inc.) was added into the crucible, placed in a high-temperature furnace (DENG YNG DFH-20), and heated at 950 to 1000° C. for 30 minutes to 1 hour for heat treatment. After completing the heat treatment, the quartz crucible was placed at room temperature for cooling to obtain Carbon Black 1.

### Production Example 2: Production of Carbon Black 2

Carbon Black 2 was obtained in the same manner as in Production Example 1 except that the heat treatment was carried out using microwave equipment.

### [Modified Recycled Carbon Black]

### Production Examples 3 and 4: Carbon Black 3 and Carbon Black 4

According to the conditions shown in Table 1, Carbon Black 3 and Carbon Black 4 can be produced by modifying the aforementioned Carbon Black 1 with the carbon material post-modification treatment system disclosed in Taiwan Patent No. 1796678B. The content of Taiwan Patent No. 1796678B is incorporated herein by reference in its entirety.

TABLE 1

| | Carbon black | Quantitative | Rotation speed | Ozone | Ozone | Reaction |
|---|---|---|---|---|---|---|
| Production | feed amount | pacemaker | of reactor | flow rate | concentration | time |
| Example | per batch (Kg) | (%) | screw (%) | (L/min) | (g/m³) | (minutes) |
| 3 | 7~10 | 18~30 | 50~70 | 60~100 | 140~180 | 40~60 |
| 4 | | | | | | 80~120 |

Table 2 shows the nitrogen adsorption specific surface area (NSA), carbon black oil absorption number (OAN), and volatile content of the recovered carbon black and the carbon black of Production Examples 1 to 4. The measurement items listed in Table 2 were carried out in the following manner:

### [NSA]

The specific surface area of carbon black was measured according to ASTM D6556. The pressure of gas adsorbed and desorbed on the surface and pores of carbon black at a constant temperature was measured, and the nitrogen surface area was deemed as the total surface area of the outer surface area and the inner surface area according to the BET theoretical formula. The specific surface area is calculated using the gas molecule cross-sectional area, gas molecule volume and sample weight.

$$\frac{P}{{V}_{a} ( {P}_{0} - P )} = \frac{1}{{V}_{m} C} + \frac{C - 1}{{V}_{m} C} \times \frac{P}{{P}_{0}}$$

P is the pressure, P₀ is the saturation pressure, Vₐ is the total absorption volume, C is the BET constant, and Vₘ is the gas volume required to form a single layer.

### [OAN]

Carbon black OAN was measured according to ASTM D2414. A quantitative carbon black was weighed and titrated to the end point using white mineral oil with a density of 1.042˜1.047 g/cm³. The absorption value was calculated based on the weight and titration amount of the carbon black sample, and then substituted into the following formula to obtain the OAN value.

$$D = \frac{V}{M} \times 100$$

D: White mineral oil (petroleum) absorption value of soot, V: Volume of white mineral oil (petroleum) consumed, M: Sample weight

### [Volatile Content]

The organic compounds (including but not limited to residual oil, adhesives, surface functional groups, etc.) released by baking carbon black at 950° C. for 7 minutes were measured. The weights of the crucible before and after the burning of the carbon black were measured respectively to calculate the loss percentage for obtaining the released amount of the organic compounds.

TABLE 2

| | PB- | Production | Production | Production | Production |
|---|---|---|---|---|---|
| | 365 | Example 1 | Example 2 | Example 3 | Example 4 |
| NSA (m²/g) | 66.1 | 67.9 | 66.2 | 68.2 | 70.2 |
| OAN (mL/100 g) | 97.3 | 129.2 | 116.3 | 102.8 | 124.5 |
| Volatile content | 3.45 | 0.41 | 0.30 | 1.77 | 2.64 |
| (weight %) | | | | | |

As shown in Table 2, the recycled carbon black that has been heat treated (Production Examples 1 and 2) has lower volatile content than the recycled carbon black that has only been thermally cracked, which shows that the present disclosure can indeed significantly reduce the content of the organic compound impurities in the recovered carbon black through heat treatment to improve its purity. The experimental results of the modified recycled carbon black (Production Examples 3 and 4) show that the heat-treated high-purity carbon black (Production Examples 1 and 2) can be further modified according to the user's needs to obtain the desired properties, such as polarity, dispersion, light absorption, coloring, etc. among others. Because the modified carbon black has oxygen-containing functional groups on its surface, the modified recycled carbon black (Production Example 3) has higher volatile content than the recycled carbon black that has only been heat treated (Production Examples 1 and 2), and the longer the modification time (Production Example 4), the more the oxygen-containing functional groups accumulated on the surface of carbon black, which means that the volatile content will increase again.

Table 3 shows the tests of the content of polycyclic aromatic hydrocarbons in the recycled carbon black before heat treatment (PB-365), the recycled carbon black after heat treatment (Production Example 1), and the modified recycled carbon black (Production Example 3), which were measured using a gas chromatography mass spectrometer (Agilent 5977B GC/MSD) in accordance with the 2019 edition of the GS PAH specification (AfPS GS 2019:01 PAK), which shows that the 15 PAHs content of the recycled carbon black after heat treatment and the modified recycled carbon black is 0 and shows that the 15 PAHs content of the recycled carbon black can be reduced to less than 0.2 ppm by heat treatment.

TABLE 3

| | | | PB- | Production | Production |
|---|---|---|---|---|---|
| Test Item | Unit | MDL | 365 | Example 1 | Example 3 |
| Naphthalene | mg/Kg | ≤0.2 | 1.60 | ND | ND |
| Phenanthrene | mg/Kg | ≤0.2 | 1.00 | ND | ND |
| Anthracene | mg/Kg | ≤0.2 | ND | ND | ND |
| Fluoranthene | mg/Kg | ≤0.2 | ND | ND | ND |
| Pyrene | mg/Kg | ≤0.2 | ND | ND | ND |
| Benzo[a]anthracene | mg/Kg | ≤0.2 | ND | ND | ND |
| Chrysene | mg/Kg | ≤0.2 | ND | ND | ND |
| Benzo[b]fluoranthene | mg/Kg | ≤0.2 | ND | ND | ND |
| Benzo[j]fluoranthene | mg/Kg | ≤0.2 | ND | ND | ND |
| Benzo[k]fluoranthene | mg/Kg | ≤0.2 | ND | ND | ND |
| Benzo[e]pyrene | mg/Kg | ≤0.2 | ND | ND | ND |
| Benzo[a]pyrene | mg/Kg | ≤0.2 | ND | ND | ND |
| Indeno[1,2,3-cd]pyrene | mg/Kg | ≤0.2 | ND | ND | ND |
| Dibenzo[a,h]anthracene | mg/Kg | ≤0.2 | ND | ND | ND |
| Benzo[g,h,i]perylene | mg/Kg | ≤0.2 | ND | ND | ND |
| 15PAHs | mg/Kg | | 2.60 | 0.00 | 0.00 |

<Note>:
1. MDL: Detection limit value.
2. ND: Not detected.

Table 3-1 shows the results of measuring the recycled carbon black (PB-365) and the carbon black of Production Example 1 and Production Example 3 using XPS (PHI Quantera II, ULVAC-PHI Inc). The C1s binding energy of the XPS spectrum was calibrated with a standard value of 285.6 eV. After that, a curve fitting procedure was used to determine the content of carbon-carbon bonds and each oxygen-containing functional group. The fitted binding energy for each functional group is: 285.4 eV for C—C bond, 286 eV for C—O bond, 287 eV for C—O bond, 289.6 eV for COOH bond. The sum of the areas of all peaks after fitting is 100%.

Table 3-1 shows that the oxygen-containing functional group content of the carbon black of Production Example 1 and Production Example 3 is less than 70%, which is lower than that of the recycled carbon black before heat treatment (PB-365). It proves that the impurity content of organic compounds in the heat-treated recycled carbon black (Production Example 1) has been significantly reduced, compared to the recycled carbon black before heat treatment (PB-365). It also proves that the modified recycled carbon black (Production Example 3) accumulates oxygen-containing functional groups on its surface due to the oxidation reaction so that the modified recycled carbon black has a higher oxygen-containing functional group content than the recycled carbon black that has only been heat treated (Production Example 1). However, the oxygen-containing functional group content of the modified recycled carbon black is still lower than that of the recycled carbon black before heat treatment (PB-365).

TABLE 3-1
Area of peaks (%)

| Binding | Functional | | Production | Production |
|---|---|---|---|---|
| Energy (eV) | Group | PB-365 | Example 1 | Example 3 |
| C4 (289.6) | COOH | 5.64 | 1.53 | 7.55 |
| C3 (287) | C═O | 21.11 | 19.72 | 18.53 |
| C2 (286) | C—O | 43.22 | 35.32 | 29.49 |
| C1 (285.4) | C—C | 30.03 | 43.43 | 44.43 |

Oxygen-containing functional group content (%)

| | | | |
|---|---|---|---|
| C4x2 + C3 + C2 | 75.61 | 58.1 | 63.12 |

FIG. 1(a) shows an XRD pattern of the recovered carbon black after heat treatment (Production Example 1); and FIG. 1(b) shows an XRD pattern of the recovered carbon black before heat treatment (PB-365). FIG. 1 shows that the heat-treated recycled carbon black has characteristic peaks of crystalline silicon (Si) at 2θ positions of 28.38°, 47.26°, 56.08°, 69.08° and 76.37° (the source of which is the ash in waste tires), and a characteristic broad peak of amorphous silica (SiO₂) at 2θ positions of 15˜30°. FIG. 1 shows that compared to the recycled carbon black before heat treatment, the content of pure silicon in the recycled carbon black after heat treatment increases (the peak width of the characteristic peak is narrower, and the intensity of the characteristic peak is higher).

### Example: Manufacturing of Metallic Paint

The ingredients listed in Table 4 were mixed according to the proportions shown. The carbon black was modified recycled carbon black (Production Example 3) in Example 1, and commercially available virgin carbon black (Mitsubishi Chemical MA100; NSA 110 m²/g, OAN 100 mL/100 g and volatile content 1.5% by weight) in Comparative Example 1. After mixing, a high-speed mixer was used to mix evenly, and the resulting slurry was added to a paint mixer (RADIA Red Devil 1400-0H) for milling. A fineness meter to was used determine the fineness every hour until the fineness is less than 10 microns. Next, a solvent was added to adjust the viscosity of Example 1 and Comparative Example 1 to the same range (i.e., the viscosity was FC #4 60±10 seconds), thereby obtaining a metallic paint.

TABLE 4

| Metallic paint composition | weight parts |
|---|---|
| A136-70 (solid content 70%) (Dali Polymer) | 114 |
| Cross-linking agent Melamine MR-625 (solid | 20 |
| content 76%) (Changchun Chemical) | |
| Dispersant BYK-118 (solid content 80%) | 1.5 |
| Carbon black | 15 |
| Defoaming agent BYK-057 (solid content 40%) | 0.5 |
| Leveling agent POLYFLOW No. 90 (Kyoeisha | 3 |
| Chemical) | |
| Thinner | 45 |

<Note>
Thinner: BCS/Xylene/#150-40/40/20, wherein #150 refers to paint solvent-150 (High-Flash Aromatic Naphtha-150).

The metallic paint was coated with a wire rod on the hiding power test chart (Table 5) and tinplate (Table 6), and baked at 130° C. for 30 minutes. Next, the gloss was measured with a gloss meter (Dr Lange REFO 3), and the blackness and hue were measured with a colorimeter (X-rite Ci7600). When measuring blackness and hue, SCE* (specular light removal) mode was used to eliminate specular reflection light and truly represent the colors seen by the human eye. The test results are shown in Table 5 and Table 6 respectively, where ΔE*_{ab}=\sqrt{(L*₂−L′₁)²+(a*₂−a*₁)²+(b*₂−b*₁)²}.

TABLE 5

| | | Comparative |
|---|---|---|
| Carbon Black | Example 1 | Example 1 |
| Viscosity (seconds) | 69 | 64 |
| Gloss 60° | 72.0 | 79.7 |
| Hue | | |
| L* | 13.13 | 12.90 |
| a* | −0.15 | −0.38 |
| b* | −0.51 | −1.67 |
| ΔE*_{ab} | 1.20 | STD |
| Blackness | | |
| My | 180.04 | 181.09 |
| dM | 1.47 | 4.7 |

TABLE 6

| | | Comparative |
|---|---|---|
| Carbon Black | Example 1 | Example 1 |
| Viscosity (seconds) | 69 | 64 |
| Gloss 60° | 76.1 | 77.9 |
| Hue | | |
| L* | 8.7 | 9.0 |
| a* | 0.16 | −0.3 |
| b* | −0.19 | −1.52 |
| ΔE*_{ab} | 1.44 | STD |

Blackness

| | | |
|---|---|---|
| My | 201.51 | 199.98 |
| dM | 0.4 | 4.88 |

From the results in Table 5 and Table 6, it can be seen that the metallic paints of Example 1 and Comparative Example 1 both have the same blackness (My) and similar chromaticity (ΔE′_{ab}) on different substrates, which shows that although the modified carbon black of the disclosure (Production Example 3) is made from recycled carbon black as raw material, it has properties close to those of commercially available virgin carbon black (Comparative Example 1). Therefore, the modified carbon black made from recycled carbon black can be used to directly replace commercially available virgin carbon black in the original formula of the coating or ink with minimal changes to the original formula.

In summary, the present disclosure can effectively purify the recycled carbon black by applying heat treatment to the recycled carbon black, and obtain modified carbon black that can replace commercially available virgin carbon black through modification, thereby improving the applicability and economic value of the recycled carbon black. Since the carbon black of the present disclosure is produced from recycled carbon black, the carbon black of the present disclosure is also an environmentally friendly carbon black and has great application value.

Those described above are only preferred embodiments of the present disclosure, and should not be used to limit the scope of the present disclosure. That is, any equivalent change or modification simply made in accordance with the claims and detailed description of the present disclosure is still within the claimed scope of the present disclosure.

What is claimed is:

1. A carbon black produced by performing a heat treatment on a recycled carbon black and meeting the following conditions: less than 3.4% by weight of volatile content; and about 2 ppm or less of polycyclic aromatic hydrocarbons.

2. The carbon black of claim 1, wherein the volatile content is equal to or less than 3.2% by weight.

3. The carbon black of claim 2, wherein the volatile content is greater than about 0% by weight and less than or equal to about 2.9% by weight.

4. The carbon black of claim 1, further meeting the following conditions: an oil absorption number of about 150 mL/100 g or less.

5. The carbon black of claim 4, wherein the oil absorption number is about 140 mL/100 g or less.

6. The carbon black of claim 5, wherein the oil absorption number is between about 100 mL/100 g and about 135 mL/100 g.

7. The carbon black of claim 1, further meeting the following conditions: a nitrogen adsorption specific surface area of about 40 m²/g or more.

8. The carbon black of claim 7, wherein the nitrogen adsorption specific surface area is about 60 m²/g or more.

9. The carbon black of claim 8, wherein the nitrogen adsorption specific surface area is between about 65 m²/g and about 150 m²/g.

10. A method for preparing carbon black of claim 1, comprising: (1) providing a recycled carbon black; and (2) performing a heat treatment on the recycled carbon black.

11. The method of claim 10, wherein the recycled carbon black is obtained by performing pyrolysis on tires.

12. The method of claim 10, wherein the heat treatment is performed at a temperature equal to or greater than about 800° C.

13. The method of claim 12, wherein the heat treatment lasts for about 10 minutes or more.

14. The method of claim 10, further comprising: (3) modifying the recycled carbon black after the heat treatment.

15. The method of claim 14, wherein the modification is performed with an oxidizing agent.

16. The method of claim 15, wherein the modification is performed with ozone.

17. A coating or ink containing the carbon black of claim 1.
